(19) United States
(12) Patent Application Publication
(10) Pub. No.: US 2010/0053077 A1
(43) Pub. Date: Mar. 4, 2010

(54) NOTEBOOK COMPUTER WITH FORCE FEEDBACK FOR GAMING

(76) Inventors: Jih-Hung Huang, Taipei (TW); Yu-Chuan Shen, Taipei (TW); Chi-Yi Liu, Taipei (TW); Wen-Chou Liu, Taipei (TW)

Correspondence Address: Muncy, Geissler, Olds & Lowe, PLLC, P.O. BOX 1364, FAIRFAX, VA, 22038-1364, US

(21) Appl. No.: 12/538,478

(22) Filed: Aug. 10, 2009

(30) Foreign Application Priority Data
Aug. 26, 2008 (TW) 97132492

(51) Int. Cl. G09G 5/00; G09G 3/00

(52) U.S. Cl. 345/156; 340/407.1

(57) ABSTRACT

A notebook computer with force feedback for gaming is provided. A vibrating plate is disposed on a host, and a vibration generating device is disposed at the bottom of the vibrating plate to generate vibration when a computer game is executed. Thus, a user playing the computer game may feel the force feedback. Additionally, to prevent vibration from affecting the normal operation of the host, a damper is disposed between the host and the vibrating plate to prevent vibration from being transmitted to the host.

### BACKGROUND OF THE INVENTION

1. Field of the Invention

The invention relates to a notebook computer with force feedback for gaming and, more particularly, to a notebook computer which provides physical feeling feedback while gaming without damaging the host.

2. Description of the Related Art

Generally, to make a player feels real while gaming, it is a trend to implement the feature of force feedback on the game system. A video game console providing vibration on a game paddle is the most commonly used. In specific game scenes, vibration is used to provide user force feedback, which makes the user feel real while gaming.

However, although there are various games played on a computer, the force feedback design in the computer is not as common as that in the video game console. To take a desktop computer system as an example, a mouse and a keyboard are the most common operation interfaces. In the conventional technology, a force feedback interface is combined with a mouse. When the user plays a computer game with the mouse, the force feedback effect also may be achieved.

However, to a computer game, the keyboard is the main operation interface. Especially to a notebook computer, to facilitate the carrying, a user does not always bring the mouse every time. In addition, main electronic components such as a hard disk, a motherboard and a CPU are located at the bottom of the computer, which is different from the desktop computer. If force feedback is designed at the keyboard, the whole notebook computer is affected by the vibration and the working electronic components such as the hard disk may be damaged. The problem is not solved for a long time, and thus when a user plays a game on the notebook computer, he can only receive the sound and image feedback, but cannot receive the force feedback.

Therefore, the conventional technology also discloses a force feedback design that can be combined with the mouse, the keyboard and even the notebook computer. However, to avoid affecting the operation of the notebook computer, the feedback mode is tactile feedback. In other words, an actuator is used to make a salient point or a roller shake slightly. This only may be defined as a half-simulative force feedback, its effect cannot make the user feel while gaming.

### BRIEF SUMMARY OF THE INVENTION

The invention discloses a notebook computer with force feedback for gaming including a liquid crystal display (LCD), a host, a vibrating plate, a vibration generating device and a damper. The LCD and the host are pivotally connected to each other, and the LCD may be closed or open relative to the host. The host has a keypress portion to allow a user to input information. The vibrating plate is disposed at the assembling area of the host and adjacent to the keypress portion. The vibration generating device corresponds to the vibrating plate and is disposed at the inner side of the host. When a game runs on the host of the computer, vibration may be generated to provide the user with force feedback for gaming and make the user feel while gaming.

In another aspect, to prevent the vibration of force feedback from damaging the host, the damper is disposed between the vibrating plate and the host to separate the host from the vibrating plate. Thus, vibration generated by the vibration generating device only may be transmitted to the vibrating plate rather than to the host, and it is isolated effectively. Thus, the host may be operated normally, and force feedback for gaming may be provided to the user when the computer game is run.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing the notebook computer with force feedback for gaming in an embodiment of the invention;

FIG. 2 is a schematic diagram showing the combination of the vibration generating device of the notebook computer with force feedback for gaming in an embodiment of the invention;

FIG. 3 is a schematic diagram showing the vibrating state of the vibration generating device of the notebook computer with force feedback for gaming in an embodiment of the invention;

FIG. 4 is a partial exploded diagram of the notebook computer with force feedback for gaming in an embodiment of the invention;

FIG. 5 is a schematic diagram showing that the damper separates the vibrating plate in the notebook computer from force feedback for gaming in an embodiment of the invention; and

FIG. 6 is a schematic diagram showing the notebook computer with force feedback for gaming in another embodiment of the invention.

### DETAILED DESCRIPTION OF THE EMBODIMENTS

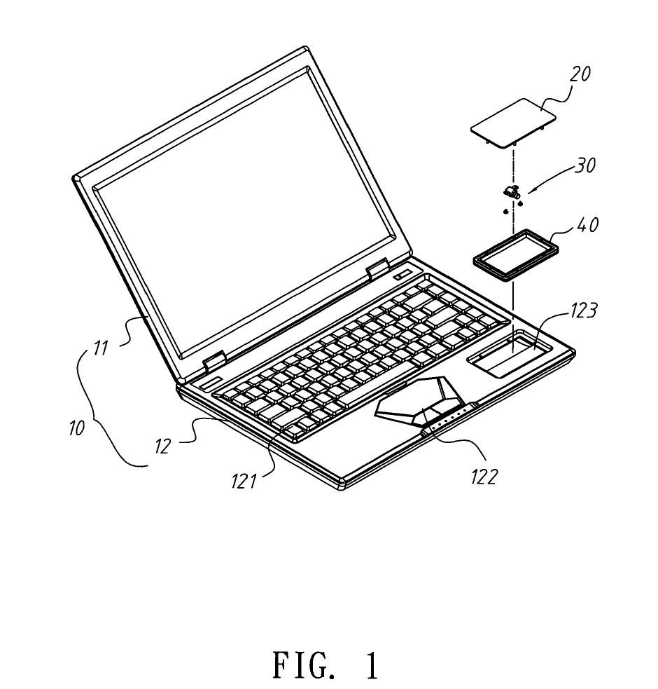

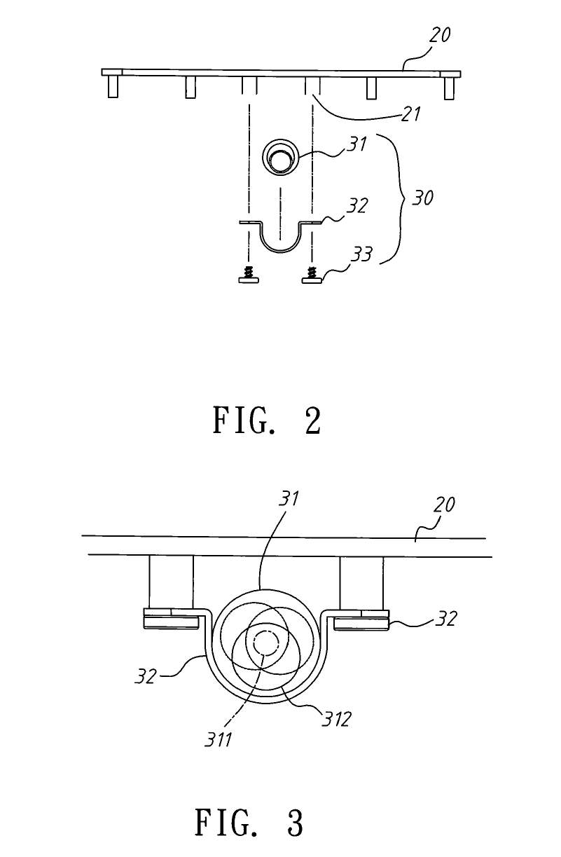

As shown in FIG. 1, the notebook computer with force feedback for gaming disclosed in the invention includes a notebook computer body 10, a vibrating plate 20, a vibration generating device 30 and a damper 40. The notebook computer body 10 includes a LCD 11 and a host 12. The LCD 11 is pivotally connected to the host 12, and it may be open and closed relative to the host 12. The LCD 11 may be open to allow a user to use and closed relative to the host 12 to allow the user to carry it conveniently. In the invention, the disclosed force feedback structure is adapted for various kinds of notebook computers. The structure in the drawing is only one aspect of the invention, and it is not limited to thereto.

The host 12 has a keypress portion 121 and a pointing device area 122 to allow the user to operate the notebook computer. Various electronic components such as a CPU, a motherboard, a hard disk and so on (not shown) are disposed inside the host 12. An assembling area 123 is adjacent to the keypress portion 121 to dispose the vibrating plate 20. The size of the vibrating plate 20 is substantially as large as that of the assembling area 123. Thus, after disposed, the vibrating plate 20 covers the assembling area 123 to keep consistency of the appearance of the host 12.

The vibration generating device 30 is disposed at the bottom of the vibrating plate 20. When the host 12 executes a game, vibration may be generated by the vibration generating device 30. Thus, the vibrating plate 20 is driven to vibrate to provide force feedback. In another aspect, a damper 40 is used to separate the vibrating plate 20 from the host 12. Thus, vibration generated by the vibration generating device 30 only drives the vibrating plate 20, and it cannot be transmitted to the host 12.

As shown in FIG, 2, it is a schematic diagram showing the combination of the vibration generating device 30 in an embodiment of the invention.

The vibration generating device 30 includes an eccentric motor 31, a carrying base 32 and screws 33. The eccentric motor 31 is carried by the carrying base 32, and the shape of the carrying base 32 is substantially the same as that of the eccentric motor 31, and thus the carrying base 32 can stably support the bottom of the eccentric motor 31. Then, the screws 33 are used to fix the carrying base 32 and the eccentric motor 31 at the vibrating plate 20 via screw holes 21. The vibration generating device 30 also may be fixed in any modes, and only a screwing mode is used as an example in the drawing.

As shown in FIG. 3, it is a schematic diagram showing the vibrating state of the vibration generating device 30 in an embodiment of the invention.

A rotor 312 of the eccentric motor 31 is eccentric relative to an axle center 311. When the eccentric motor 31 works and the axle center 311 drives the rotor 312 to rotate, the eccentric motor 31 may vibrate. At that moment, since the eccentric motor 31 is fixed by the carrying base 32, the carrying base 32 vibrates along with the eccentric motor 31. To avoid that the eccentric motor 31 may fall from the carrying base 32 after used for a long time, as shown in FIG. 3, the carrying base 32 may cover more than a half sectional area of the eccentric motor 31 to improve the fixing effect. In addition, a sticking or welding process also may be used to improve the stableness. Furthermore, since the carrying base 32 is fixed to the vibrating plate 20 through the screws 33, vibration generated by the vibration generating device 30 may be transmitted to the vibrating plate 20 through the carrying base to make the vibrating plate 20 vibrate.

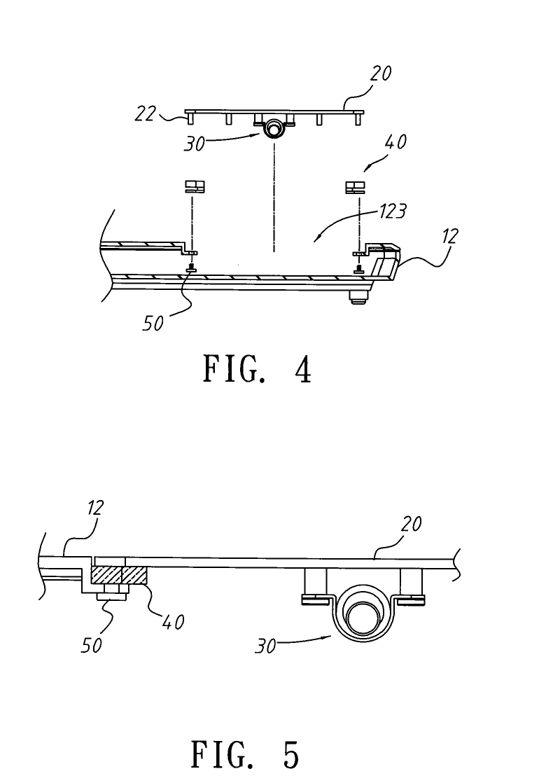

As shown in FIG. 4 and FIG. 5, they are partial exploded diagrams of the notebook computer with force feedback for gaming in an embodiment of the invention.

The vibration generating device 30 is disposed at the vibrating plate 20. After the damper 40 separates the vibrating plate 20 from the host 12, the vibration generating device is assembled at the assembling area 123 of the host 12. The vibrating plate 20 has multiple locating pillars 22 to allow the user to locate the damper 40 conveniently. Then, the screw 50 is used to fix the vibrating plate 20 and the damper 40 in the assembling area 123. The damper 40 is made of rubber, silicon gel, elastic polymer or other materials. Thus, it may absorb vibration effectively. As shown in FIG. 5, the area where the edge of the vibrating plate 20 contacts the host 12 is separated by the damper 40. Vibration generated by the vibration generating device 30 is absorbed and isolated, and it may be transmitted to the vibrating plate 20 rather than the host 12. Thus, possibility of damaging on the components in the host 12 is reduced.

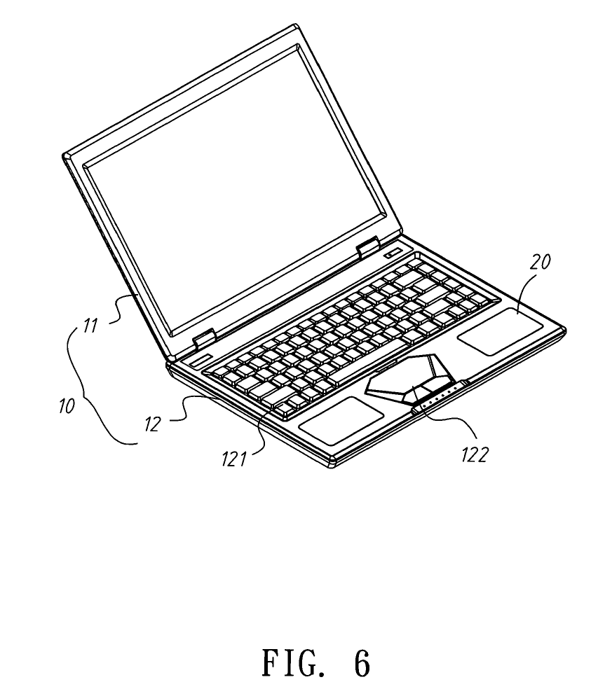

When the user plays computer games on the notebook computer, vibration generated by the vibration generating device 30 is transmitted to the vibrating plate 20. Thus, the user may feel force feedback. In another aspect, when the keypress portion 121 is used to play the game, the user usually operates the keypress portion 121 with both hands. Thus, as shown in FIG. 6, there are two vibrating plates 20 designed lower than the keypress portion 121 of the host 12, and they may be located at the position corresponding to the user's wrists or arms to give the user direct force feedback.

In the notebook computer with force feedback for gaming according to the invention, with the cooperation of the vibration generating device, the vibrating plate and the damper, force feedback may be generated and is provided to the user when he plays the computer game. With the design of the damper, vibration is not transmitted to the host to damage the electronic components, and the user may feel while gaming.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A notebook computer, comprising:
a host having a keypress portion;
a vibrating plate disposed on the host and adjacent to the keypress portion;
a vibration generating device corresponding to the vibrating plate and disposed at the inner side of the host to generate vibration when the host executes a computer game; and
a damper disposed between the vibrating plate and the host to prevent the vibration from being transmitted to the host.

2. The notebook computer according to claim 1, wherein the vibration generating device is an eccentric motor.

3. The notebook computer according to claim 1, wherein the damper is made of rubber, silicon gel, elastic polymer or composition thereof.

4. The notebook computer according to claim 1, wherein the host has an assembling area corresponding to the vibrating plate for disposing the vibrating plate.
